(19) United States
(12) Patent Application Publication
(10) Pub. No.: US 2020/0074872 A1
(43) Pub. Date: Mar. 5, 2020

(54) METHODS AND SYSTEMS FOR DISPLAYING QUESTIONS FOR A MULTIMEDIA

(71) Applicant: STREAMINGO SOLUTIONS PRIVATE LIMITED, Bangalore (IN)

(72) Inventors: Sanjeev KILARAPU, Bangalore (IN); Sharath MANJUNATH, Leeming (AU); Vidhya T. V, Bangalore (IN); Vinay T. S, Bangalore (IN)

(73) Assignee: STREAMINGO SOLUTIONS PRIVATE LIMITED, Bangalore (IN)

(21) Appl. No.: 16/115,431

(22) Filed: Aug. 28, 2018

(51) Int. Cl. G09B 7/00

(52) U.S. Cl. CPC G09B 7/00

(57) ABSTRACT

The embodiments herein provide methods and systems for displaying questions for a multimedia including at least one chapter, a method includes generating a plurality of questions based on content of the multimedia. The plurality of questions are assigned with at least one score. The method includes determining at least one relevant question from the plurality of questions for the at least one chapter of the multimedia. The method includes selecting a question from the at least one relevant question for the at least one chapter based on the at least one score. The method includes displaying the question with a higher score while watching the at least one chapter of the multimedia. Further, the method includes analyzing an answer received by a user for the question displayed to the user. Based on the answer received by the user, the method includes displaying a subsequent question based on a difficulty tag.

### TECHNICAL FIELD

The embodiments herein relate to electronic devices and, more particularly to displaying questions for a multimedia.

### BACKGROUND

Generally, multimedia (for example, videos) is being used to share information and messages on the Internet. Multimedia helps to satisfy the very zeal of reviewing, revisiting and revising intent while accessing the information.

Furthermore, information gathering from the multimedia is often non-interactive. Because of the non-interactive nature of the multimedia and due to limited viewer attention span, the viewer may likely disengage with the multimedia of a longer duration. Viewer disengagement with the multimedia may result in significant drop in interest to view/understand the rest of the video. Therefore, multimedia content providers provide questions related to the watched multimedia to evaluate, analyze, review and reflect the viewer understanding and learning intent.

In existing approaches, the multimedia content providers may use manual techniques to display the questions after watching the multimedia. However, the manual techniques are not scalable in presence of large numbers of multimedia content. Also, the questions may be displayed without relating to the content of the multimedia. Thus, the questions displayed may be irrelevant. In addition, the questions can be displayed to the viewer without understanding the skill sets/interests of the viewer. Moreover, it is not possible to display the questions, once the multimedia has been published online, without causing sonic amount of disruption to the viewer's online experience.

### BRIEF DESCRIPTION OF THE FIGURES

The embodiments disclosed herein will be better understood from the following detailed description with reference to the drawings, in which:

FIG. 1 is a block diagram illustrating various units of an electronic device for generating and displaying questions for a multimedia, according to embodiments as disclosed herein;

FIG. 2a is a flow diagram illustrating a method for generating and displaying questions for a multimedia, according to embodiments as disclosed herein;

FIG. 2b is a flow diagram illustrating a method for adaptively displaying questions for a multimedia, according to embodiments as disclosed herein;

FIG. 3 is an example block diagram illustrating selection of questions for chapters of a multimedia, according to embodiments as disclosed herein; and

FIG. 4 is an example block diagram illustrating display of questions and analysis of user answering patterns for the displayed questions, according to embodiments as disclosed herein.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein provide methods and systems for displaying questions for a multimedia, wherein the multimedia includes one or more chapters.

A method disclosed herein includes generating a plurality of questions based on content of the multimedia. The plurality of questions can be assigned with one or more scores (as disclosed in Indian Patent Application 201842001026). Further, the method includes determining relevant questions from the plurality of questions for the one or more chapters of the multimedia. Further, the method includes selecting a question from the relevant questions for the one or more chapters based on the one or more scores. After selecting the question, the method includes displaying the question with a higher score selected from the relevant questions while watching the one or more chapters of the multimedia.

Further, the method includes assigning one or more difficulty tags to the relevant questions determined for the one or more chapters. The difficulty tags can be, but is not limited to, an easy tag, a medium tag, a difficulty tag and so on. Further, the method includes analyzing an answer received from a user for the displayed question. Based on the analysis of the answer, the method includes displaying a subsequent question based on the one or more difficulty tags.

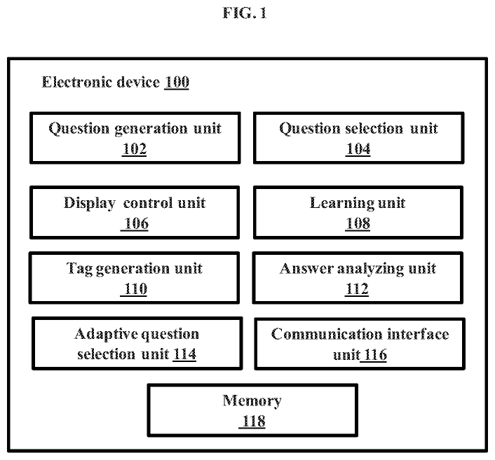

Referring now to the drawings, and more particularly to FIGS. 1 through 4, where similar reference characters denote corresponding features consistently throughout the figures, there are shown embodiments.

FIG. 1 is a block diagram illustrating various units of an electronic device 100 for generating and displaying questions for a multimedia, according to embodiments as disclosed herein.The electronic device 100 can be at least one of, but is not limited to, a mobile phone, a smartphone, tablet, a phablet, a personal digital assistant (PDA), a laptop, a computer, a wearable computing device, a smart TV, a wearable device (for example, smart watch, smart hand), and an IoT (Internet of Things) device or any other electronic device which has the capability of accessing and playing multimedia content or accessing an application (such as a browser) which can access and display multimedia content. The multimedia can be for example, in the form of video, audio and video, textual content present in image and video format, animations with audio, text and so on. The multimedia can include at least one chapter. Based on context of content of the multimedia, the at least one chapter can be generated for the multimedia. The generation of the at least one chapter for the multimedia is disclosed in U.S. application Ser. No. 15/786,077.

The electronic device 100 includes a question generation unit 102, a question selection unit 104, a display control unit 106, a learning unit 108, a tag generation unit 110, an answer analyzing unit 112, an adaptive question selection unit 114, a communication interface unit 116 and a memory 118.

The question generation unit 102 can be configured to generate a plurality of questions for the multimedia. The plurality of questions can be, but is not limited to, at least one descriptive question, at least one multiple choice question (MCQ), at least one fill in the blank question, at least one true/false question and so on. The plurality of questions can be generated based on the content of the multimedia. The plurality of questions can be generated from the multimedia (for example, spoken audio or a text recognized from the spoken audio in the media) under analysis using but not limited to, machine learning (ML), natural language processing (NLP) techniques, or the like. Further, the plurality of questions can be tagged with domain relevance and chapters/the time sections inside the multimedia based on sentences of the plurality of questions (as disclosed in Indian Patent Application 201842001026).

The question generation unit 102 can be further configured to assign scores to the plurality of questions using machine learning techniques. The scores can be assigned based on factors such as, but not limited to, grammar usefulness, learning value, relevancy and so on (as disclosed in Indian Patent Application 201842001026).

The question selection unit 104 can be configured to determine relevant questions for the chapters of the multimedia. The question selection unit 104 identifies chapter tagged with a question of the plurality of questions. After identifying the chapter tagged with the question, the question selection unit 104 performs mapping of the chapter tagged with the question of the plurality of questions with a chapter of the multimedia. Based on successful mapping, the question selection unit 104 selects the question as a relevant question for the chapter of the multimedia. Thus, one or more relevant questions can be selected for the chapter of the multimedia.

Consider an example, wherein 10 questions may be generated for a video which comprises of 5 chapters. The question selection unit 104 maps a chapter tagged to each question with each chapter. Based on successful mapping, the question selection unit 104 may select 2 relevant questions for each chapter of the video. In an embodiment, number of relevant questions may vary based on the domain relevance/chapters tagged with the plurality of questions.

The question selection unit 104 can be further configured to select a question from the relevant questions for display while watching the chapter of the multimedia. The question selection unit 104 analyzes the scores assigned to the relevant questions selected for the chapter of the multimedia to select the question for display. In an embodiment, the question with a higher score can be selected to display for the chapter. The higher score may represent the question having more usefulness, more learning value, higher relevancy and so on.

In an embodiment, the question selection unit 104 may select at least one of a single question and one or more questions from the relevant questions to display for the chapter of the multimedia. Thus, number of questions selected for display for each chapter may vary according to factors such as, but not limited to, scores, importance, priority, usefulness, relevancy and so on.

The display control unit 106 can be configured to display the question received from the question selection unit 104 to a user while watching the chapter of the multimedia. The user herein refers to a person who views the multimedia. The user can be, but is not limited to, a viewer, a student, and so on, in an embodiment, the display control unit 106 may display remaining questions according to requirements of the user. The remaining questions can be, but is not limited to, the questions which are not selected as the relevant questions from the plurality of questions, the questions which are not selected from the relevant questions for display for the chapter based on the scores and so on. For example, if the user wishes to watch additional questions at an end of watching the multimedia, then the user can select a toggle button provided by the display control unit 106. Once the toggle button is selected, the display control unit 106 displays the remaining questions after watching the multimedia.

Further, the display control unit 106 may receive inputs from an administrator of the multimedia. The inputs can be, but is not limited to, a new question, an edited/modified question, removal/deletion of question and so on. The display control unit 106 provides the inputs received from the administrator to the learning unit 108.

The learning unit 108 can be configured to perform actions based on the inputs received from the administrator of the multimedia. The action can include at least one of updating the relevant questions by adding at least one of the new question and the edited question as the relevant questions, deleting at least one question from the relevant question and selecting at least one of the new question and the edited question to display for the chapter of the multimedia. The learning unit 108 may provide the selected at least one of the new question and the edited question to the display control unit 106 for display while watching the chapter of the multimedia.

The tag generation unit 110 can be configured to assign a difficulty tag to the relevant questions selected for the chapters of the multimedia based on levels of difficulty. The difficulty tag specifies whether the question is easy or the question is difficult. The difficulty tag can be, but is not limited to, an easy tag, a medium tag and a difficult tag. The tag generation unit 110 may use pre-defined templates to generate the difficulty tag for the relevant questions selected for the chapters of the multimedia. The pre-defined templates can be, but is not limited to, a template with ‘Who/When/What’ or the like terms, a template with ‘How’ or the like terms, a template with ‘Describe/Explain’ or the like terms and so on. When a relevant question matches with the template including ‘Who/When/What’ terms, then the tag generation unit 110 assigns the easy tag to the relevant question. When a relevant question matches with the template including ‘How’ term, then the tag generation unit 110 assigns the medium tag to the relevant question. Similarly, when a relevant question matches with the template including ‘Describe/Explain’ terms, then the tag generation unit 110 assigns the difficult tag to the relevant question.

The answer analyzing unit 112 can be configured to analyze an answer received from the user for the displayed question. The display control unit 106 can receive the answer from the user for the displayed question. In an embodiment, on receiving the answer from the user for the displayed MCQ question, the answer analyzing unit 112 compares the answer with the pre-generated correct answer. If the answer provided by the user does not match with the correct answer, the answer analyzing unit 112 may predict that the answer provided by the user is incorrect. If the answer provided by the user matches with the correct answer, the answer analyzing unit 112 may predict that the answer provided by the user is correct. In an embodiment, the answer analyzing unit 112 may allow the administrator associated with the multimedia to analyze the answer provided by the user for the descriptive question.

The adaptive question selection unit 114 can be configured to select subsequent questions for display for the chapters depending on the analysis of the answer received from the user and the difficulty tag. When the answer analyzing unit 112 predicts that the answer received from the user is correct, the adaptive question selection unit 114 may select at least one of the question with the medium tag and the question with the difficult tag as subsequent question. Similarly, when the answer analyzing unit 112 predicts that the answer received from the user is incorrect, the adaptive question selection unit 114 may select the question with the easy tag as the subsequent question. Further, the adaptive question selection unit 114 provides the subsequent question to the display control unit 106 for display while watching the chapter of the multimedia. In an embodiment, in case of selection of a single question to display for the chapter, the adaptive question selection unit 114 may select the question based on the difficulty tag for subsequent/next chapter based on analysis of the answer received from the user. The question may be selected from the relevant questions associated with the next chapter based on the difficulty tag.

The communication interface unit 116 can be configured to establish communication between the electronic device 100 and at least one external entity such as a network.

The memory 118 can be configured to store multimedia, the questions generated for the multimedia, the scores and the difficulty tags assigned to the questions, results of analysis of the answer received from the user and so on. The memory 118 may include one or more computer-readable storage media. The memory 118 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 118 may, in some examples, be considered a non-transitory storage medium. The term “non-transitory” may indicate that the storage medium is not embodied in a carrier wave or a propagated signal. However, the term “non-transitory” should not be interpreted to mean that the memory 118 is non-movable. In some examples, the memory 118 can be configured to store larger amounts of information than the memory. In certain examples, a non-transitory storage medium may store data that can, over time, change (e.g., in Random Access Memory (RAM) or cache).

FIG. 1 shows exemplary units of the electronic device 100, but it is to be understood that other embodiments are not limited thereon. In other embodiments, the electronic device 100 may include less or more number of units. Further, the labels or names of the units are used only for illustrative purpose and does not limit the scope of the embodiments herein. One or more units can be combined together to perform same or substantially similar function in the electronic device 100.

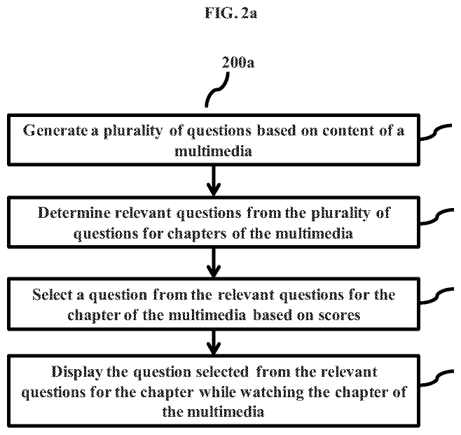

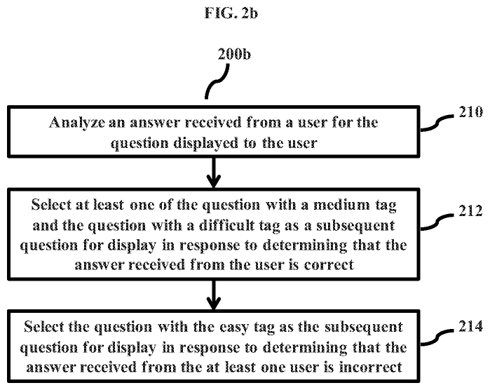

FIG. 2a is a flow diagram 200a illustrating a method for displaying the questions for the multimedia including at least one chapter, according to embodiments as disclosed herein.

At step 202, the method includes generating the plurality of questions based on the content of the multimedia. The method allows the question generation unit 102 to generate the plurality of questions based on the content of the multimedia. The plurality of questions can be tagged with the associated chapters and the scores. Generating the plurality of questions and assigning the scores for the plurality of questions is discloses in Indian Patent Application 201842001026.

At step 204, the method includes determining the relevant questions from the plurality of questions for the chapters of the multimedia. The method allows the question selection unit 104 to determine the relevant questions from the plurality of questions for the chapters of the multimedia. The question selection unit 104 identifies chapters tagged with the plurality of questions. The question selection unit 104 maps the chapters tagged with the plurality of questions with the chapters of the multimedia. In response to determining that at least one chapter tagged with at least one question of the plurality of questions can be mapped with at least one chapter of the multimedia, the question selection unit 104 selects the corresponding at least one question as the relevant question for the at least one chapter of the multimedia.

At step 206, the method includes selecting the question from the relevant questions for the chapter of the multimedia based on the scores. The method allows the question selection unit 104 to select the question from the relevant questions for the chapter of the multimedia based on the scores. The question selection unit 104 analyzes the scores assigned to the relevant questions and selects the question with the higher score for the chapter of the multimedia.

At step 208, the method includes displaying the question selected from the relevant questions for the chapter while watching the chapter of the multimedia. The method allows the display control unit 106 to display the question selected from the relevant questions for the chapter while watching the chapter of the multimedia. The question with the higher score may be displayed. Thus, displaying the questions for each chapter creates highly engaged viewing experience and also provides ability to the user to assess learning efficiently.

The various actions, acts, blocks, steps, or the like in the method and the flow diagram 200a may be performed in the order presented, in a different order or simultaneously. Further, in some embodiments, some of the actions, acts, blocks, steps, or the like may be omitted, added, modified, skipped, or the like without departing from the scope of the invention.

FIG. 2b is a flow diagram 200b illustrating a method for adaptively displaying the questions for the multimedia, according to embodiments as disclosed herein.

At step 210, the method includes analyzing the answer received from the user for the question displayed to the user. The method allows the answer analyzing unit 112 to analyze the answer received from the user for the question displayed to the user.

At step 212, the method includes selecting at least one of the question with the medium tag and the question with difficult tag as the subsequent question for display in response to determining that the answer received from the user is correct. The method allows the adaptive question selection unit 114 to select at least one of the question with the medium tag and the question with difficult tag as the subsequent question for display in response to determining that the answer received from the at least one user is correct.

At step 214, the method includes selecting the question with the easy tag as the subsequent question for display in response to determining that the answer received from the user is incorrect. The method allows the adaptive question selection unit 114 to select selecting the question with the easy tag as the subsequent question for display in response to determining that the answer received from the at least one user is incorrect. Thus, the questions can be displayed to the user based on skill sets of the user.

The various actions, acts, blocks, steps, or the like in the method and the flow diagram 200b may be performed in the order presented, in a different order or simultaneously. Further, in some embodiments, some of the actions, acts, blocks, steps, or the like may be omitted, added, modified, skipped, or the like without departing from the scope of the invention.

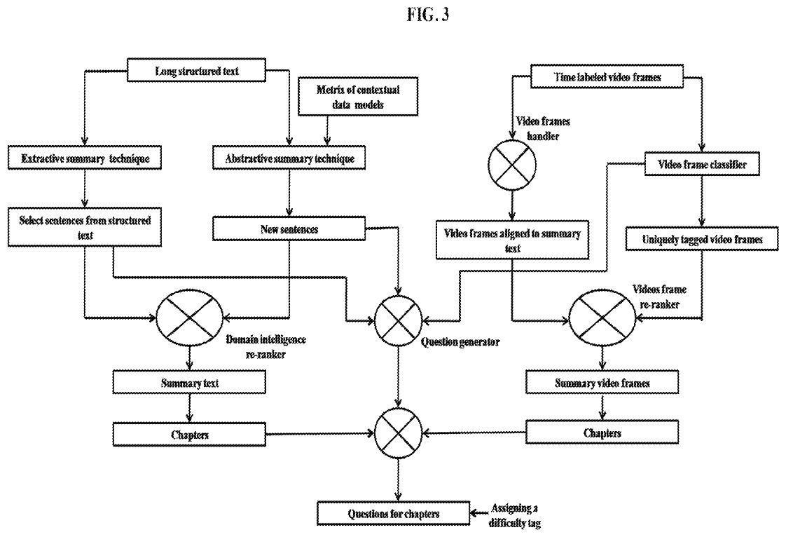

FIG. 3 is an example block diagram illustrating selection of questions for chapters of a multimedia, according to embodiments as disclosed herein.

The question generation unit 102 can generate the plurality of questions based on the content of the multimedia (as disclosed in Indian Patent Application 201842001026). For example, the multimedia may comprise two chapters. Content of the first chapter of the multimedia can be “What is the purpose of any communication system? The purpose of any communication system is to transmit some signal, which is generated by a source to a destination through a media or channel. So, there is a source, which is generating some electrical signal, which is possibly captured from some real life image or audio. And, then the signal generated by a transducer and then that needs to be transmitted to a destination through a media which is technically called the channel”.

The questions generated based on the content of the first chapter of the multimedia may be:
Q1: How can the purpose of any communication system transmit some signal, which is generated by a source to a destination through a media or channel?
Q2: What is the purpose of any communication system?
Q3: What generates some signal?
Q4: What generates some electrical signal, which is possibly captured from some real life image or audio?
Q5: What is a transducer?
Q6: What is it and how can it generate the electrical signal?

The questions Q1-Q6 can be tagged with the domain relevancy/chapters. Thus, the questions Q1-Q6 can be tagged with the first chapter.

Similarly, content of a second chapter can be “A transducer is a device that converts energy from one form to another. Usually a transducer converts a signal in one form of energy to a signal in another” The questions generated for the second chapter may be:
Q7: What is a transducer?
Q8: Which device converts energy form one form to another?
Q9: Describe a transducer.

The questions Q7-Q9 can be tagged with the domain relevancy/the second chapter. Thus, the multimedia may comprise 9 questions.

Further, the questions Q1-Q9 can be assigned with the scores based on usefulness, learning value, relevancy and so on. For example, the scores assigned to the questions Q1-Q7 can be:
Q1: How can the purpose of any communication system transmit some signal, which is generated by a source to a destination through a media or channel? (Score 304.62)
Q2: What is the purpose of any communication system? (Score 358.62)
Q3: What generates some signal? (Score 302.1)
Q4: What generates some electrical signal, which is possibly captured from some real life image or audio? (Score 310.36)
Q5: What is a transducer? (Score 308.6)
Q6: What is it and how can it generate the electrical signal? (Score 299.6)

The scores assigned to the questions Q7-Q9 can be:
Q7: What is a transducer? (Score 360)
Q8: Which device converts energy form one form to another? (Score 289)
Q9: Describe a transducer. (Score 340)

Embodiments herein allow the tag generation unit 110 to assign the difficulty tag for the questions Q1-Q8 which represents a level of difficulty. The tag generation unit 110 uses the pre-defined templates to assign the tags for the questions Q1-Q9. The pre-defined templates can be, but is not limited to, a template including ‘Who/What/When’ or the like terms, a template including ‘How’ or the like terms, a template including ‘Describe/Explain’ or the like terms and so on. The tag generation unit 110 assigns the easy tag to the question when the question matches with the template including ‘Who/What/When’ terms. The tag generation unit 110 assigns the medium tag to the question when the question matches with the template including ‘How’ term. Similarly, the tag generation unit 110 assigns the difficult tag to the question when the question matches with the template including ‘Describe/Explain’ terms. For example, the difficulty tag assigned to the questions Q1-Q9 can be
Q1: How can the purpose of any communication system transmit some signal, which is generated by a source to a destination through a media or channel? (Medium tag)
Q2: What is the purpose of any communication system? (Easy tag)
Q3: What generates some signal? (Easy tag)
Q4: What generates some electrical signal, which is possibly captured from some real life image or audio? (Easy tag)
Q5: What is a transducer? (Easy tag)
Q6: What is it and how can it generate the electrical signal? (Medium tag)
Q7: What is a transducer? (Easy tag)
Q8: Which device converts energy form one form to another? (Easy tag)
Q9: Describe a transducer (Difficulty tag)

In order to display the questions for the first chapter of the multimedia, the question selection unit 104 selects the questions Q1-Q6 as relevant questions from the questions Q1-Q9 for the first chapter. The question selection unit 104 selects the questions Q1-Q6 for the first chapter by performing mapping of the chapter tagged with the questions Q1-Q9 with the first chapter. As the first chapter is tagged with the questions Q1-Q6, the question selection unit 104 selects the questions Q1-Q6 for the first chapter.

After selecting the relevant questions, the question selection unit 104 analyzes the scores assigned to the relevant questions Q1-Q6 and selects the question from the Q1-Q6 to display while watching the first chapter of the multimedia. The question selection unit 104 may select the question Q2 for the first chapter as the question Q2 is assigned with the higher score and instructs the display control unit 106 to display the question Q2 while watching the first chapter of the multimedia 104. In an embodiment, the question selection unit 104 may select the questions Q2 and Q4 based on the scores to display while watching the first chapter of the multimedia.

Similarly, the question selection unit 104 selects the questions Q7-Q9 as relevant questions for the second chapter. Further, the question selection unit 104 selects the question Q7 for the second chapter as the question Q7 is assigned with the higher score and instructs the display control unit 106 to display the question Q7 while watching the second chapter of the multimedia.

Further, according to the user requirements, the display control unit 106 may display remaining questions (which are not displayed while watching any of the chapters) after watching the multimedia as additional questions. The remaining questions may include at least one question from the questions Q1, Q3, Q5, Q6, Q8 and Q9.

In an embodiment, the learning unit 108 may receive information about the inputs provided by the administrator of the multimedia. For example, the input may include an edited form of the question Q6. Based on the input, the learning unit 108 may update the question Q6 and the score for the Q6 may be updated accordingly. Further, if the administrator assigns the higher score for question Q6, then the learning unit 108 selects the question Q6 for the first chapter and instructs the display control unit 106 to display the question Q6 while watching the first chapter of the multimedia. Similarly, if the input received from the administrator suggests for removal of the question Q3, the learning unit 108 removes the questions Q3 from a list of questions generated for the first chapter of the multimedia.

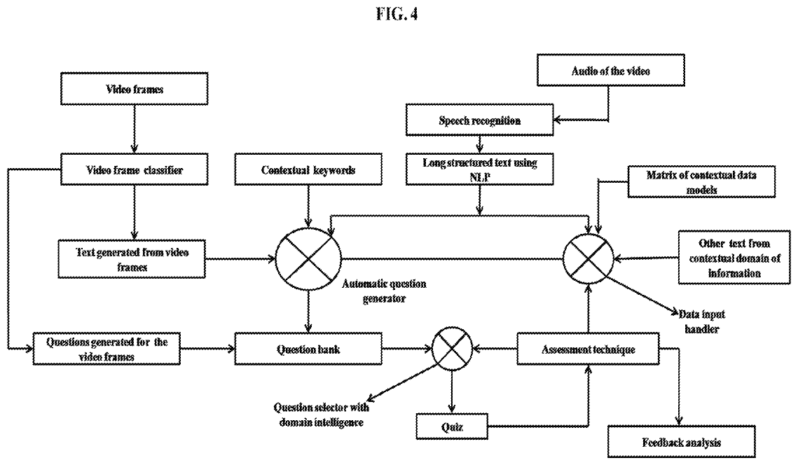

FIG. 4 is an example block diagram illustrating display of questions and analysis of user answering patterns, according to embodiments as disclosed herein.

Embodiments herein enable the question generation unit 102 to receive contextual keywords present in sentences of text transcript output to generate the plurality of questions. The question generation unit 102 transforms visual description of video frames into generating the plurality of questions. Also, the question generation unit 102 generates new questions for visual patterns inside the video frames. Further, the question generation unit 102 maintains a question bank which is indexed using tagged questions with the domain relevance and with the time sections inside the video/chapters.

The embodiments herein can generate a question bank of questions for a particular domain using documents/video frames from the domain. These can later be used to test the understanding of the viewer. The question bank generation described here in adds a unique value to the existing video systems, textbooks, audio podcasts and all relevant sources of information gathering. The question bank can be automatically generated by adding the questions generated based on the textual information extracted from the video frames. For example, the extracted textual information from the video frames is shown below:

Sample text: “What is the purpose of any communication system? The purpose of any communication system is to transmit some signal, which is generated by a source to a destination through a media or channel. So, there is a source, which is generating some electrical signal, which is possibly captured from some real life image or audio. And, then the signal generated by a transducer and then that needs to be transmitted to a destination through a media which is technically called the channel”.

Further, the extracted textual information is passed to a semantic parser and then the parsed output is compared with the predefined templates. Further, the questions can be generated when the parsed sentence matches with the predefined template.

For the sample text given in the paragraph 0061, below are the possible questions generated:
1. How can the purpose of any communication system transmit some signal, which is generated by a source to a destination through a media or channel?
2. What is the purpose of any communication system?
3. What generates some signal?
4. What generates some electrical signal, which is possibly captured from some real life image or audio?
5. What is a transducer?
6. What is it and how can it generate the electrical signal?

Once, all possible questions are generated, the generated questions are sent to the filtering stage. The filtering can be performed to extract only relevant questions and filter the unwanted questions. The filtering stage includes keywords filtering, pronoun filtering or the like.The keyword based filtering includes extracting keywords and key phrases from the extracted textual information. For example, for the sample text provided above, the keywords and key phrases can be, communication system, transmit, channel, electrical signal, transducer or the like. Further, based on the keywords and key phrases, the question generation unit 102 can be configured to filter the generated question based on the keywords and key phrases. The above generated questions can be filtered based on the keywords and key phrases (for example, communication system, transmit, channel, electrical signal, transducer or the like). The filtered questions based on the keywords and key phrases are shown below:
1. How can the purpose of any communication system transmit some signal, which is generated by a source to a destination through a media or channel?
2. What is the purpose of any communication system?
3. What generates some electrical signal, which is possibly captured from some real life image or audio?
4. What is a transducer?
5. What is it and how can it generate the electrical signal?

Further, the questions can be filtered using pronouns. For example, if the pronoun occurs in a main clause of the sentence, then that question can be discarded. Once the generated questions are filtered using keywords and key phrases, the questions can further be filtered based on the pronouns. For example, the filtered questions based on the pronouns are shown below:
1. How can the purpose of any communication system transmit some signal, which is generated by a source to a destination through a media or channel?
2. What is the purpose of any communication system?
3. What generates some electrical signal, which is possibly captured from some real life image or audio?
4. What is a transducer?

Once the questions are filtered using the above techniques, the filtered questions can be filtered based on number of words. Any question without having a keyword/key phrase or a noun phrase and having very few words, or too many words can be discarded. The output of filtering based on number of words as given below:
1. What is the purpose of any communication system?
2. What generates some electrical signal, which is possibly captured from some real life image or audio?
3. What is a transducer?

Further, the filtered questions can be added to the question bank, wherein each question may include keywords/tags. Thus, the questions from the question bank may be popped based on the keywords while playing the video frames.

Embodiments herein allow the tag generation unit 110 to tag the relevant question with the difficulty tag. Thus, adaptive tests/quiz can be generated by displaying the questions with varying levels of difficulty.

For example, initially, the display control unit 106 displays the question (selected from the relevant questions for the first chapter) with the higher score while watching a first chapter of the video frames. The display control unit 106 receives the answer for the displayed question from the user. The answer analyzing unit 112 analyzes the answer received from the user and decides that whether the answer is correct or not. In response to determining that the answer is correct, the adaptive question selection unit 114 selects the question with the difficult tag (tougher question) as a next question to display while watching the first chapter of the video frames. In response to determining that the answer is incorrect, the adaptive question selection unit 114 selects the question with the easy tag (easy tag) as the next question while watching the first chapter of the video frames. In an embodiment, the adaptive question selection unit 114 may select the question (selected from relevant questions for a second chapter) with at least one of the easy tag and the difficult tag for the second chapter after analysis of the answer received for the question displayed for the first chapter of the video frames. Thus, receiving and analyzing the answers provided by the user break the monotony of viewing and useful to assess the understanding to check whether the learning intent has been satisfied.

The embodiments disclosed herein can be implemented through at least one software program running on at least one hardware device and performing functions to control the at least one hardware device. The electronic device 100 shown in FIG. 1 includes blocks, which can be at least one of a hardware sub-module, or a combination of hardware sub-modules and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments herein can be practiced with modification within the spirit and scope of the claims as described herein.

What is claimed is:

1. A method for displaying questions for a multimedia, wherein the multimedia includes at least one chapter, the method comprising:
generating, by an electronic device, a plurality of questions based on content of the multimedia, wherein the plurality of questions are assigned with at least one score;
determining, by the electronic device, at least one relevant question from the plurality of questions for the at least one chapter of the multimedia;
selecting, by the electronic device, a question from the at least one relevant question for the at least one chapter of the multimedia based on the at least one score; and
displaying, by the electronic device, the question selected from the at least one relevant question for the at least one chapter while watching the at least one chapter of the multimedia.

2. The method of claim 1, wherein determining the at least one relevant question includes
identifying at least one chapter tagged with at least one question of the plurality of questions, wherein the at least one chapter is tagged with the at least one question of the plurality of questions based on the at least one sentence;
mapping the at least one chapter tagged with the at least one question of the plurality of questions with the at least one chapter of the multimedia; and
relating the at least one question as the at least one relevant question for the at least one chapter in response to determining the at least one chapter tagged with the at least one question is mapped with the at least one chapter of the multimedia.

3. The method of claim 1, wherein selecting the question from the at least relevant question for the at least one chapter includes
analyzing the at least one score associated with the at least one relevant question selected for the at least one chapter; and
selecting the question with a higher score for display while watching the at least one chapter of the multimedia.

4. The method of claim 1, further comprising:
receiving, by the electronic device, information about at least one input received from an administrator of the multimedia, wherein the at least one input includes at least one of at least one new question, at least one edited question and information about at least one deleted question; and
performing, by the electronic device, at least one action based on the at least one input received from the administrator, wherein the at least one action include at least one of using the at least one input for updating the at least one relevant question for the at least one chapter and selecting the at least one input as the question for display while watching the at least one chapter of the multimedia.

5. The method of claim 1, further comprises assigning, by the electronic device, at least one difficulty tag to the at least one relevant question for the at least one chapter, wherein the at least one difficulty tag includes at least one of an easy tag, a medium tag and a difficult tag.

6. The method of claim 1, further comprises:
analyzing, by the electronic device, an answer received from at least one user for the question displayed to the at least one user;
selecting, by the electronic device, at least one of the question with the medium tag and the question with the difficult tag as a subsequent question for display in response to determining the answer received from the at least one user is correct; and
selecting, by the electronic device, the question with the easy tag as a subsequent question for display in response to determining the answer received from the at least one user is incorrect.

7. An electronic device for displaying questions for a multimedia, wherein the multimedia includes at least one chapter, the electronic device comprising:
a question generation unit configured to:
generate a plurality of questions based on content of the multimedia, wherein the plurality of questions are assigned with at least one score;
a question selection unit configured to:
determine at least one relevant question from the plurality of questions for the at least one chapter of the multimedia; and
select a question from the at least one relevant question for the at least one chapter of the multimedia based on the at least one score; and
a display control unit configured to:
display the question selected from the at least one relevant question for the at least one chapter while watching the at least one chapter of the multimedia.

8. The electronic device of claim 7, wherein the question selection unit is further configured to:
identify at least one chapter tagged with at least one question of the plurality of questions, wherein the at least one chapter is tagged with the at least one question of the plurality of questions based on the at least one sentence;
map the at least one chapter tagged with the at least one question of the plurality of questions with the at least one chapter of the multimedia; and
relate the at least one question as the at least one relevant question for the at least one chapter in response to determining the at least one chapter tagged with the at least one question is mapped with the at least one chapter of the multimedia.

9. The electronic device of claim 7, wherein the question selection unit is further configured to:
analyze the at least one score associated with the at least one relevant question selected for the at least one chapter; and
select the question with a higher score for display while watching the at least one chapter of the multimedia.

10. The electronic device of claim 7, wherein the electronic device further comprises a learning unit configured to:
receive information about at least one input received from an administrator of the multimedia, wherein the at least one input includes at least one of at least one new question, at least one edited question and information about at least one deleted question; and
perform at least one action based on the at least one input received from the administrator, wherein the at least one action include at least one of using the at least one input for updating the at least one relevant question for the at least one chapter and selecting the at least one input as the question for display while watching the at least one chapter of the multimedia.

11. The electronic device of claim 7, wherein the electronic device further comprises a tag generation unit configured to assign at least one difficulty tag to the at least one relevant question selected for the at least one chapter, wherein the at least one difficulty tag includes an easy tag, a medium tag and a difficult tag.

12. The electronic device of claim 7, wherein the electronic device further comprises:
an answer analyzing unit configured to:
analyze an answer received from at least one user for the question displayed to the at least one user; and
an adaptive question selection unit configured to:
select at least one of the question with the medium tag and the question with the difficult tag as a subsequent question for display in response to determining the answer received from the at least one user is correct; and
select the question with the easy tag as a subsequent question for display in response to determining the answer received from the at least one user is incorrect.
